(19) United States
(12) Patent Application Publication
(10) Pub. No.: US 2006/0071593 A1
(43) Pub. Date: Apr. 6, 2006

(54) Light emitting device with controlled thickness phosphor

(76) Inventors: Kheng Leng Tan, Penang (MY); Tajul Arosh Baroky, Penang (MY); Janet Bee Yin Chua, Perak (MY); Kok Chin Pan, Penang (MY); Kee Yean Ng, Penang (MY)

Correspondence Address: AVAGO TECHNOLOGIES, INC., P.O. BOX 1920, DENVER, CO, 80201-1920, US

(21) Appl. No.: 10/959,005

(22) Filed: Oct. 5, 2004

(51) Int. Cl. H05B 33/04; H05B 33/10

(52) U.S. Cl. 313/512; 313/499; 445/25

(57) ABSTRACT

A method for packaging a light emitting device, in which a primary light generator, such as a light emitting diode semiconductor die or laser diode, is attached to a lead frame and covered with a body of phosphor material so as to form a predetermined thickness of phosphor material covering the primary light generator. The body of phosphor material may be contained in a substantially transparent container or preformed, compressed disc. The resulting light emitting device has a primary light generator covered by phosphor material that is constrained to have a predetermined thickness.

### FIELD

This invention relates generally to the field of light emitting devices. More particularly, this invention relates to a light emitting device that combines a primary light generator, such as light emitting diode or a laser diode and phosphor.

### BACKGROUND

Conventional white light emitting devices use a solid-state semiconductor light emitting diode die covered by a phosphor coating. The light emitting diode (LED) typically emits a primary ultraviolet or blue light and the phosphor coating converts the wavelength of some the light into secondary light to form white light. In manufacture, the phosphor is suspended in a solid or gel host matrix and then coated onto the semiconductor die. A disadvantage of this method is that the coating has an uneven thickness. This results in non-uniform conversion of the primary light and is detrimental to the optical properties of the light emitting device. Consequently, the manufacturing yield is reduced.

### SUMMARY

The present invention relates generally to white light emitting devices. Objects and features of the invention will become apparent to those of ordinary skill in the art upon consideration of the following detailed description of the invention.

In accordance with one aspect of the invention a light emitting device is packaged by covering a primary light generator, such as a light emitting diode or laser diode semiconductor die, with a preformed body of phosphor material, thereby creating a predetermined thickness of phosphor material covering the light emitting diode semiconductor die. The resulting light emitting device has a primary light generator covered by phosphor material that is constrained to have a predetermined thickness.

### BRIEF DESCRIPTION OF THE DRAWINGS

The novel features believed characteristic of the invention are set forth in the appended claims. The invention itself, however, as well as the preferred mode of use, and further objects and advantages thereof, will best be understood by reference to the following detailed description of an illustrative embodiment when read in conjunction with the accompanying drawing(s), wherein:

FIG. 1 is representation of a light emitting device of the prior art.

FIG. 2 is sectional view of a light emitting device in accordance with an embodiment of the present invention.

FIG. 3 is sectional view of a light emitting device in accordance with a further embodiment of the present invention.

FIG. 4 is a sectional view of a container of a light emitting device in accordance with an aspect of one embodiment of the present invention.

FIG. 5 is side view of a light emitting device in accordance with a still further embodiment of the present invention.

FIG. 6 is top view of the light emitting device shown in FIG. 5.

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

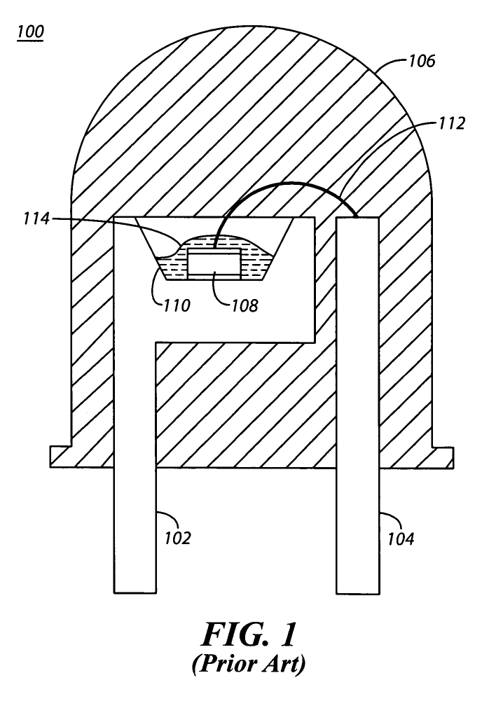

FIG. 1 is representation of a light emitting device of the prior art. Referring to FIG. 1, a light emitting device 100 includes a cathode lead frame 102 and an anode lead frame 104 encapsulated in an epoxy dome lens 106. The cathode lead frame 102 supports a light emitting diode (LED) semiconductor die 108 in a well or reflector cup 110. A wire bond 112 provides an electrical connection from the anode lead frame 104 and the LED semiconductor die 108. For a white light emitting device, phosphor is added into a solid or gel host matrix 114 covering the LED semiconductor die 108. The host matrix 114 is dispensed into the reflector cup 110 or applied as a conformal coating. A disadvantage of this method is that the coating of solid or gel host matrix material has an uneven thickness. This results in non-uniform conversion of the primary light and is detrimental to the optical properties of the light emitting device. Consequently, the manufacturing yield is reduced.

In the light emitting device of the present invention, the phosphor is packaged to provide consistent coverage of a primary light generator.

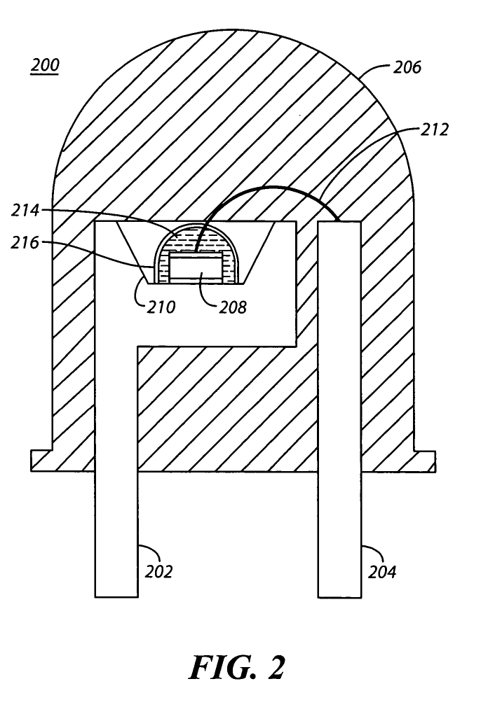

A first embodiment of a light emitting device of the present invention is shown in FIG. 2. Referring to FIG. 2, a light emitting device 200 includes a cathode lead frame 202 and an anode lead frame 204 encapsulated in an encapsulation material 206. The encapsulation material may, for example, be a thermosetting material. The cathode lead frame 202 supports a primary light generator 208, such as a light emitting diode (LED) semiconductor die or laser diode in a well or reflector cup 210. The primary light generator 208 may be a visible light generator, used in conjunction with a binary complementary phosphor. For example, a blue light generator may be used with a yellow phosphor, or an ultraviolet light generator may be used with red green and blue phosphors. The primary light generator 208 may be flip chip. A wire bond 212 provides an electrical connection from the anode lead frame 204 to the primary light generator 208.

In this embodiment, the phosphor material 214, which comprises phosphor embedded or suspended in a host matrix material, is placed in a transparent container 216. The host matrix material may be a liquid, gel or solid. The container 216 constrains and controls the thickness of the host matrix material 214 that contains the phosphor and provides a consistent coverage of the primary light generator 208. The container 216 is substantially transparent and may be constructed of glass or polymer for example.

The host matrix material 214 containing the phosphor is tightly packed in a gaseous or liquid medium. In one embodiment liquid silicone is used. Liquid silicone provides resistance to both heat and ultraviolet light.

In prior packaging methods, the different rates of thermal expansion of the components leads to stresses on the primary light generator 208 during encapsulation. The packaging method of the present invention minimizes the stresses on the primary light generator since the host matrix material 214 isolates the primary light generator from the stresses.

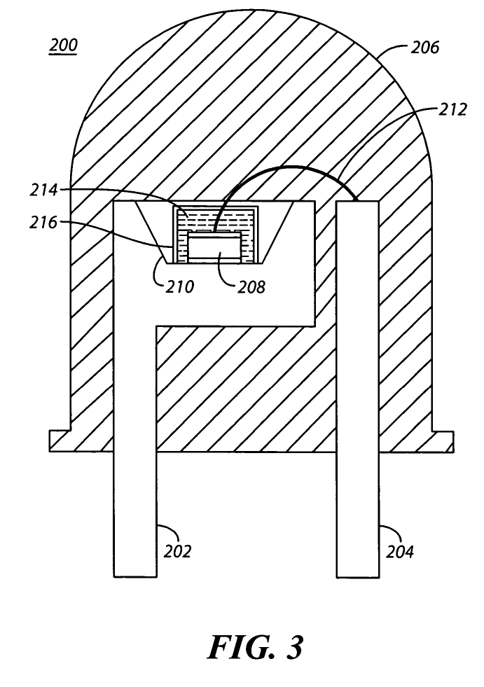

The container 216 in FIG. 2 is dome shaped. In a second embodiment, shown in FIG. 3, the container 216 has a flat top and may be a rectangular box or a cylinder for example. The container may be shaped to optimize the optical properties of the light emitting device.

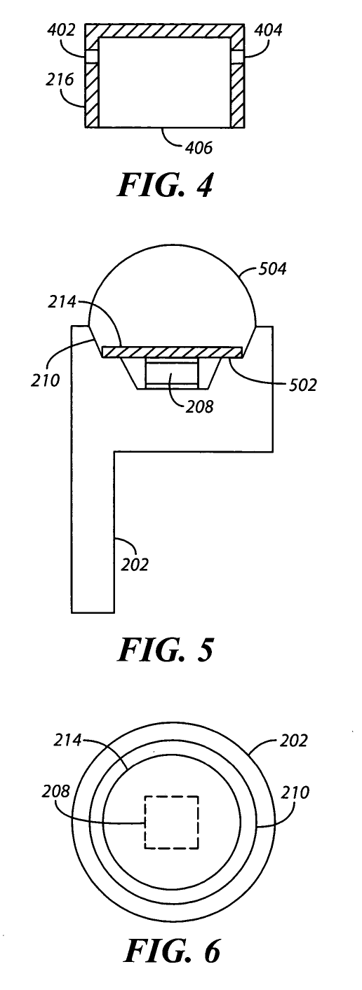

FIG. 4 is a sectional view of a container 216 of a light emitting device in accordance with an aspect of one embodiment of the present invention. Referring to FIG. 4, the container 216 has a first opening 402 that enables a wire bond to pass through the container to form an electrical connection between the lead frame and the primary light generator 208. The container also has a second opening 404 that allows phosphor host matrix material to be placed into the container after it has been attached to the lead frame. Alternatively, the second opening 404 may be omitted and the container may be filled through the opening 406 before the container is attached to the lead frame. After packaging, the openings 402 and 404 are closed using transparent material, such as a polymer, and adhesive.

A further embodiment of a light emitting device of the present invention is shown in FIG. 5. In FIG. 5, the anode lead frame has been omitted for clarity. As before, the cathode lead frame 202 supports a primary light generator 208, such as a light emitting diode (LED) or laser diode, in a well or reflector cup 210. However, in this embodiment the host matrix material 214 comprises a preformed disc. The disc is pre-compressed to reduce waste due to pot-life expiration of the material. The disc of host matrix material 214 is inserted into a lined groove 502 in the reflector cup 210. The lined groove 502 is at a specified height from the cup bottom. The primary light generator 208 is mounted in the cup 210 prior to the insertion of the disc of host matrix material 214. The disc is aligned such that it rests on the light emitting surface of the primary light generator 208, or just above it. Light emitted from the primary light generator 208 passes into the disc of host matrix material 214 and a least a portion of the light is converted in wavelength. The wavelength converted light combines with any residual unconverted light to form white light that is emitted from the device.

When the disc of host matrix material 214 is preformed, the thickness of the disc is accurately controlled. In addition, the disc is easily handled and transported.

The disc of host matrix material 214 is covered by an encapsulating material or air gap 504.

FIG. 6 is top view of the light emitting device shown in FIG. 5. The disc of host matrix material 214 is inserted in the reflector cup 210 and covers the primary light generator 208.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A method for packaging a light emitting device, comprising:
attaching a primary light generator to a lead frame; and
covering the primary light generator with a preformed body of phosphor material to form a predetermined thickness of phosphor material covering the primary light generator.

2. A method for packaging a light emitting device in accordance with claim 1, wherein the preformed body of phosphor material comprises a substantially transparent container that contains the phosphor material in a gel matrix material.

3. A method for packaging a light emitting device in accordance with claim 1, wherein the preformed body of phosphor material comprises a substantially transparent container that contains the phosphor material suspended in liquid silicone matrix material.

4. A method for packaging a light emitting device in accordance with claim 1, wherein the preformed body of phosphor material comprises a preformed disc of compressed phosphor material.

5. A method for packaging a light emitting device in accordance with claim 1, further comprising encapsulating the primary light generator and the preformed body of phosphor material in a thermosetting material.

6. A method for packaging a light emitting device, comprising:
attaching a primary light generator to a lead frame;
attaching a substantially transparent container to the lead frame; and
packing a phosphor material into the substantially transparent container; wherein the substantially transparent container encloses the primary light generator to form a predetermined thickness of phosphor material covering the primary light generator.

7. A method for packaging a light emitting device in accordance with claim 6, wherein the phosphor material is packed into the substantially transparent container through an opening in the substantially transparent container after the substantially transparent container is attached to the lead frame, and further comprising:
sealing the opening in the substantially transparent container after the substantially transparent container is packed with the phosphor material.

8. A method for packaging a light emitting device in accordance with claim 6, wherein the primary light generator is attached to the lead frame through an opening in the substantially transparent container and further comprising:
sealing the opening in the substantially transparent container after the primary light generator has been attached to the lead frame.

9. A method for packaging a light emitting device in accordance with claim 6, further comprising encapsulating the primary light generator and the preformed body of phosphor material in a thermosetting material.

10. A light emitting device comprising:
a primary light generator having a light emitting surface; and
a body of host matrix material containing phosphor and covering the light emitting surface of the primary light generator; w
herein the body of host matrix material is constrained to have a predetermined thickness.

11. A light emitting device in accordance with claim 10, wherein the primary light generator comprises a semiconductor die mounted on a lead frame and further comprising:
a substantially transparent container attached to the lead frame and enclosing the primary light generator;
wherein the body of host matrix material is contained within the substantially transparent container.

12. A light emitting device in accordance with claim 11, wherein the host matrix material is a gel medium.

13. A light emitting device in accordance with claim 11, wherein the host matrix material is liquid silicone.

14. A light emitting device in accordance with claim 11, wherein the substantially transparent container is shaped to affect the optical properties of the light emitting device.

15. A light emitting device in accordance with claim 10, wherein the body of host matrix material is preformed into a compressed disc.

16. A light emitting device in accordance with claim 15, further comprising a lead frame having a reflector cup into which the light emitting diode is mounted, wherein the compressed disc of host matrix material is inserted into a lined groove in the reflector cup above the primary light generator.

17. A light emitting device in accordance with claim 10, wherein the primary light generator and the body of host matrix material are encapsulated with a thermosetting material.

18. A light emitting device in accordance with claim 10, wherein the primary light generator is a light emitting diode.

19. A light emitting device in accordance with claim 10, wherein the primary light generator is a laser diode.
